(19) United States
(12) Patent Application Publication
(10) Pub. No.: US 2013/0209981 A1
(43) Pub. Date: Aug. 15, 2013

(54) Triggered Sounds in eBooks

(71) Applicant: Daniel Newell, West Jefferson, NC (US)

(72) Inventor: Daniel Newell, West Jefferson, NC (US)

(73) Assignee: GOOGLE INC., Mountain View, CA (US)

(21) Appl. No.: 13/397,658

(22) Filed: Feb. 15, 2012

(51) Int. Cl. G09B 5/00

(52) U.S. Cl. 434/317

(57) ABSTRACT

Trigger point information is generated for an eBook to play sounds in an eBook. A request for trigger point information is received from a client. The eBook is analyzed to determine trigger point information for the eBook. The trigger point information includes location information identifying a location of a trigger point in the eBook. The trigger information also includes sound information indicating a sound to play at the trigger point. The determined trigger point information is transmitted to the client in response to the request for trigger point information. The client is configured to track a user's reading location in the eBook and play the sound indicated by the sound information responsive to the user reading the eBook at the location of the trigger point.

### 1. FIELD OF DISCLOSURE

This invention generally relates to electronic books (eBooks) and particularly relates to the playback of sounds that are associated with locations of such eBooks.

### 2. BACKGROUND INFORMATION

Many people are transitioning from reading physical books to reading eBooks, which have many advantages over physical books, such as more portability, the ability to access the eBook from multiple electronic devices, and text search capability. In addition, eBooks are easier to purchase and are perceived as environmentally-friendly. However, existing eBooks and eBook readers do not take full advantage of their capabilities to immerse a user. For example, eBook readers often include sound generation capabilities, but eBooks do not use these capabilities to improve the user's experience.

### SUMMARY

The above and other issues are addressed by a computer-implemented method, a non-transitory computer-readable storage medium and a computer system for triggering sounds in an eBook. An embodiment of the method includes receiving trigger point information from a client. An eBook is analyzed to determine trigger point information for the eBook. The trigger point information includes information identifying a location of a trigger point in the eBook. The trigger point information also includes sound information indicating a sound to play at the trigger point. The determined trigger point information is transmitted to the client in response to the request for trigger point information. The client is configured to track a user's reading location in the eBook and play the sound indicated by the sound information responsive to the user reading the eBook at the location of the trigger point.

An embodiment of the computer-implemented system for triggering sounds in an eBook includes a non-transitory computer-readable storage medium having executable computer program instructions. The instructions include instructions for receiving trigger point information from a client. An eBook is analyzed to determine trigger point information for the eBook. The trigger point information includes information identifying a location of a trigger point in the eBook. The trigger point information also includes sound information indicating a sound to play at the trigger point. The determined trigger point information is transmitted to the client in response to the request for trigger point information. The client is configured to track a user's reading location in the eBook and play the sound indicated by the sound information responsive to the user reading the eBook at the location of the trigger point.

An embodiment of the medium stores executable computer program instructions for triggering sounds in an eBook. The instructions include instructions for receiving trigger point information from a client. An eBook is analyzed to determine trigger point information for the eBook. The trigger point information includes information identifying a location of a trigger point in the eBook. The trigger point information also includes sound information indicating a sound to play at the trigger point. The determined trigger point information is transmitted to the client in response to the request for trigger point information. The client is configured to track a user's reading location in the eBook and play the sound indicated by the sound information responsive to the user reading the eBook at the location of the trigger point.

### BRIEF DESCRIPTION OF DRAWINGS

FIG. 1 is a high-level block diagram illustrating an environment for using triggered sounds in eBooks according to one embodiment.

FIG. 2 is a high-level block diagram illustrating an example of a computer for use as a sound server or a client according to one embodiment.

FIG. 3 is a high-level block diagram illustrating a detailed view of the sound server according to one embodiment.

FIG. 4 is a high-level block diagram illustrating a detailed view of the sound module of a client according to one embodiment

FIG. 5 is a flowchart illustrating a method of obtaining trigger point information and playing accompanying sounds according to one embodiment.

FIG. 6 is a flowchart illustrating a method of determining trigger point information and sending it to a client according to one embodiment.

### DETAILED DESCRIPTION

The figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

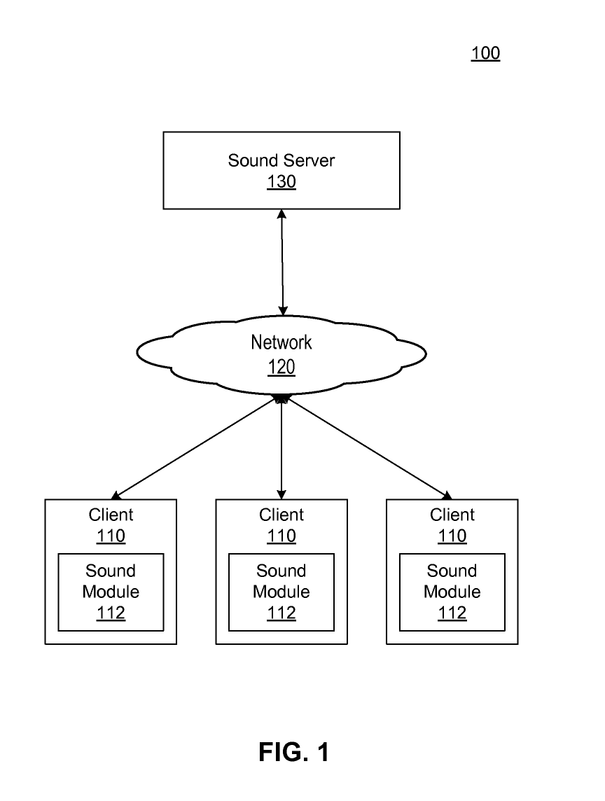

FIG. 1 is a high-level block diagram illustrating an environment 100 for using triggered sounds in eBooks according to one embodiment. As shown, the environment 100 includes multiple clients 110 connected to a sound server 130 via a network 120. While only one sound server 130 and three clients 110 are shown in FIG. 1 for clarity, embodiments can have multiple servers and many clients. Moreover, the sound server 130 may be implemented as a cloud-based service distributed across multiple physical servers.

The clients 110 are electronic devices used by one or more users to read eBooks. A client 110 can be, for example, a mobile phone, desktop, laptop, or tablet computer, or a dedicated eBook reader (“eReader”). The client 110 may execute one or more applications that support activities including reading eBooks and browsing and obtaining content available from servers on the network 120. For example, in one embodiment the client 110 is a computer running a web browser displaying eBook content from a remote website on the network 120. An eBook is a form of electronic content that is primarily textual in nature. The content of an eBook may be, for example, a novel, a textbook, or a reference book. As used herein, the term “eBook” also includes other electronic content that is primarily textual, such as magazines, journals, newspapers, or other publications.

The clients 110 include display screens that show sections of eBooks to the users. The section of text shown on a display screen at one time is referred to as a “page” of the eBook. The amount of text shown on a page by a given client 110 depends upon multiple variables including the size of the client's display screen and characteristics of the text such as typeface, font size, margin spacing and line spacing. The client 110 also includes sound generation capabilities such as internal speakers, and/or an interface to external speakers or associated sound-generation hardware. In one embodiment, the client 110 includes a forward-facing camera or other sensor to track a user's eye movement.

The user of a client 110 changes the pages of an eBook by issuing page-turn commands. The type of command issued by the user can vary based on the client 110. For example, some clients 110 have physical page turn buttons that the user presses to advance to the next or previous page. Other clients 110 have touch-sensitive display screens and the user issues a page-turn command by gesturing on the screen.

In one embodiment, a client 110 includes a sound module 112 that identifies trigger points throughout an eBook which cause sounds to be played by the client. Depending upon the embodiment, the sound module 112 can be integrated into firmware executed by the client 110, integrated into an operating system executed by the client 110, or contained within applications executed by the client 110. For example, a sound module 112 may be implemented as JAVASCRIPT code executed by a web browser on a client 110.

During normal use of the client 110 for reading an eBook, the user will issue page-turn commands as the user reads each page and advances to the next page. As the user reads, the current location in the text which the user is reading is calculated by the client 110. The current location may be calculated through various methods including eye tracking or time interval measurement. In one embodiment, the client 110 tracks where on the page the user is looking using eye-tracking based techniques.

In one embodiment, client 110 sends a trigger point information request to the sound server 130. The trigger point request may identify a portion of an eBook by indicating a start point and end point of locations in the eBook for which trigger point information is requested. The client 110 may also monitor actions of the user on the client 110 and send preference reports to the sound server 130, the preference reports indicating user preferences such as the types of music, sounds or noises that a user of client 110 likes or dislikes.

The client 110 receives trigger point information from the sound server 130 in response to the request. The trigger point information indicates trigger points at locations within the eBook and sounds to play at the trigger points. The client 110 estimates the location of the eBook at which the user is reading and plays a sound when the user reads a location having a trigger point.

The sound server 130 is a computer or other electronic device that provides trigger point information for eBooks to clients 110. The sound server 130 may be operated by an entity that provides eBooks and other electronic content to the clients 110 or may be operated by a different entity. The trigger point information includes location information specifying the location of the trigger point and sound information describing a sound to play at the trigger point.

In one embodiment, the sound server 130 analyzes portions of eBooks identified in requests to identify location information for trigger points contained therein. The sound server 130 also analyzes the eBook and/or other information to identify the sound information for the trigger points. The sound server 130 provides the trigger point information, including the location information and the sound information, to clients 110 in response to client requests.

The network 120 represents the communication pathway between the sound server 130 and clients 110. In one embodiment, the network 120 uses standard communications technologies or protocols and can include the Internet. Thus, the network 120 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 120 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 120 can be represented using technologies or formats including image data in binary form (e.g. Portable Network Graphics (PNG), the hypertext markup language (HTML), the extensible markup language (XML), etc.). In addition, all or some links can be encrypted using conventional encryption technologies such as secure sockets layer (SSL), transport layer security (TLS), virtual private networks (VPNs), Internet Protocol security (IPsec), etc. In another embodiment, the entities on the network 120 can use custom or dedicated data communications technologies instead of, or in addition to, the ones described above.

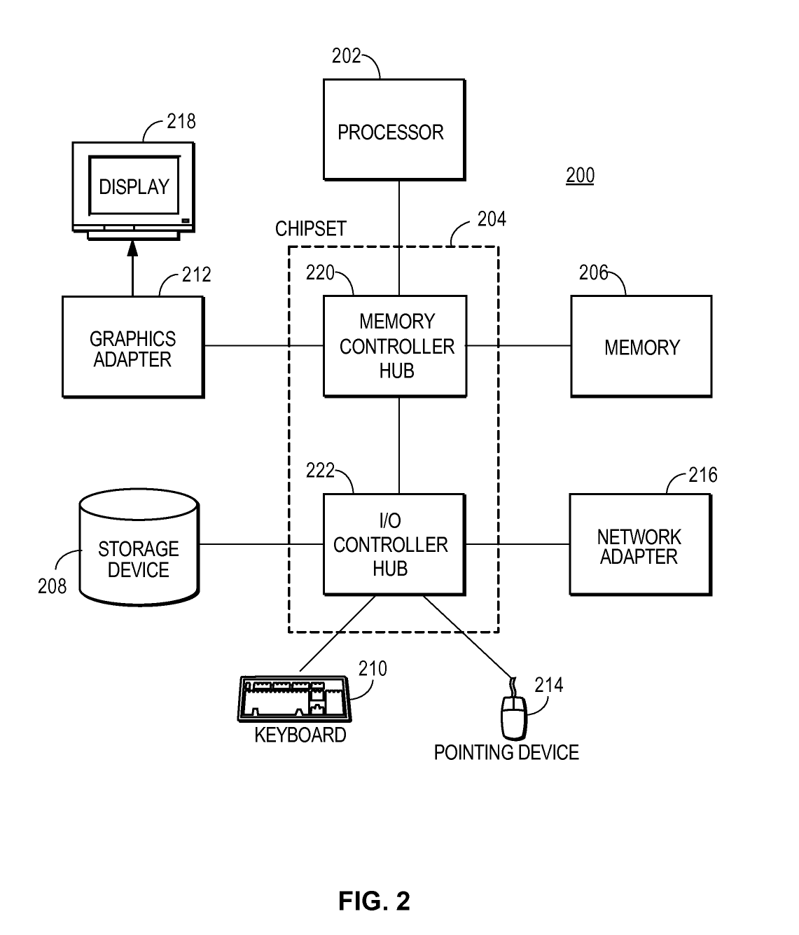

FIG. 2 is a high-level block diagram illustrating an example of a computer 200 for use as a sound server 130 or a client 110 according to one embodiment. Illustrated is at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display device 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is used in combination with the keyboard 210 to input data into the computer 200. The graphics adapter 212 displays images and other information on the display device 218. In some embodiments, the display device 218 includes touch screen capability for receiving user input and selections. The network adapter 216 couples the computer system 200 to the network 120. Some embodiments of the computer 200 have different or other components than those shown in FIG. 2. For example, the sound server 130 can be formed of multiple blade servers and lack a display device, keyboard, and other components.

The computer 200 is adapted to execute computer program modules for providing functionality described herein. As used herein, the term “module” refers to computer program instructions and/or other logic used to provide the specified functionality. Thus, a module can be implemented in hardware, firmware, or software. In one embodiment, program modules formed of executable computer program instructions are stored on the storage device 208, loaded into the memory 206, and executed by the processor 202.

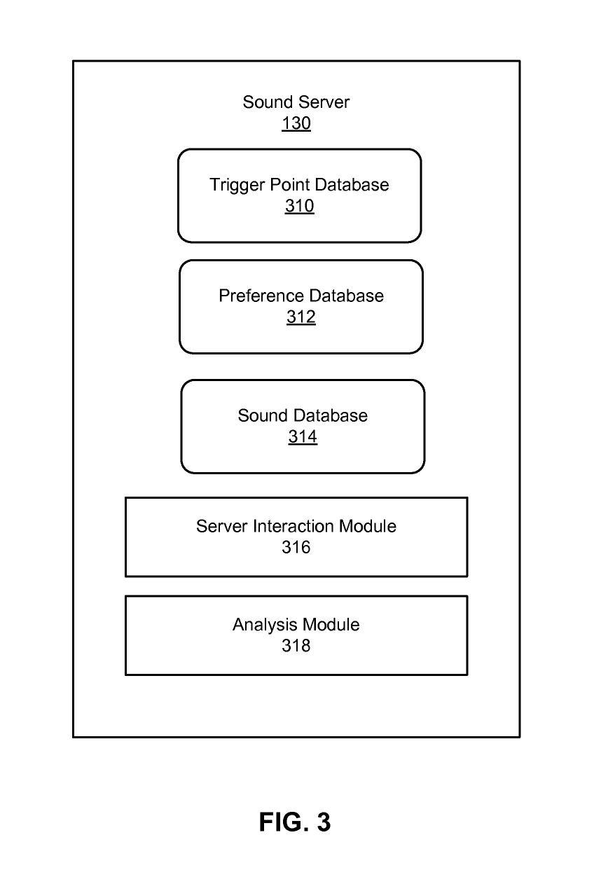

FIG. 3 is a high-level block diagram illustrating a detailed view of the sound server 130 according to one embodiment. As shown in FIG. 3, multiple modules and databases are included within the sound server 130. In some embodiments, the functions are distributed among the modules, and the data among the databases, in a different manner than described herein. Moreover, the functions are performed, or data are stored, by other entities in some embodiments, such as by the client 110 or sound module 112.

A trigger point database 310 is a data store that stores trigger point information for multiple eBooks. In one embodiment, each of the plurality of eBooks is identified using a unique identifier (ID), and the trigger point information is associated with a particular books using the book IDs. A single eBook may have many trigger points. As mentioned above, the trigger point information for a particular trigger point includes location information specifying a location of the trigger point in the eBook text and sound information describing a sound to play at the trigger point. For example, the trigger point information may indicate that a particular trigger point is located at a particular word or phrase in the text. The trigger point database 310 may store the text of the eBooks to support the functionality of the sound server 130.

The sound information may associate a specific sound with a trigger point, such that the associated sound is played when a user reads the text associated with the trigger point. For example, the sound information may associate a sound effect such as thunder, background chatter, or footsteps with a trigger point. Alternatively, the sound information may associate a sound type with a trigger point. The sound type indicates the general type of sound to play at a trigger point. For example, the sound type may indicate to play background music, and/or a particular genre of music (e.g., pop, jazz, classical) at a trigger point, without indicating the exact music to play.

In one embodiment, the sound information also specifies immediacy information for the sound associated with the trigger point. In general, the immediacy information indicates the timing of when to play the sound. In one embodiment, the immediacy information classifies a trigger point as being either a hard trigger point or a soft trigger point. The sound associated with a hard trigger point should be played as soon as the user reaches the trigger point location. In contrast, the sound associated with a soft trigger point may be played after the user reaches the trigger point location, such as after another sound completes playing. For example, a hard trigger point may be used for a particular sound effect (e.g., thunder) that should be played when the user reads particular text in the eBook. A soft trigger point may be used for background music that changes after a user reads particular text and currently-playing background music finishes. The immediacy information may also indicate other characteristics of the sound, such as whether sound should be played in isolation or concurrently with other sounds, the volume of a sound relative to other sounds, etc.

A preference database 312 is a data store that stores preferences for users of the clients 110 with respect to sound selection. In one embodiment, the stored preferences include desired volume, perceptibility, genres, tempo, preferred instruments, artists, songs, or any other information indicating preferences of the users with respect to trigger points. These preferences may be explicitly provided by the users and/or inferred from user actions. For example, a user may explicitly indicate which musical genres appeal to the user. In another example, it may be inferred that a user does not like a song that the user skips when played at a trigger point. Conversely, when a user requests more information about a song, purchases a song through the client 110, or otherwise reacts favorably to the song, it may be inferred that the user likes the song. Other actions from which user preferences may be inferred include marking a song as inappropriate for a trigger point, blacklisting a song so that it is less likely to be heard again, whitelisting a song so that it is more likely to be heard again, and rewinding or repeating a song. In addition, a user may have different sets of user preferences depending upon the eBook or type of eBook being read. If no information about certain user preferences is known, the preference database 312 may store default preferences for a user. The default user preferences may also be influenced by known data associated with the user. For example, the default preferences may be established using known demographic information about a user.

A sound database 314 is a data store that stores sounds that may be associated with trigger points and played back on the clients 110. Depending upon the embodiment, the sound database 314 may store data files storing the sounds or sound IDs referencing sounds stored elsewhere (e.g., URLs specifying locations of sound files on the network 120). For each sound, the sound database 314 may also store metadata describing the sound, such as metadata describing the genres of music within the sound files.

A server interaction module 316 receives trigger point requests from the clients 110 and provides corresponding trigger point information in response thereto. Additionally, the server interaction module 316 may receive preference reports from the clients 110 indicating user preferences and update the preference database 312. A trigger point request from a client 110 may include a book ID identifying the eBook for which the trigger points are being requested, a start point identifying the starting point in the eBook text for which trigger points are being requested, an end point identifying the ending point in the eBook text for which trigger points are being requested, and a user ID identifying the user. The server interaction module 316 uses the trigger point request to identify the section of a book bounded by the start and end points for which trigger point information is requested. In addition, the server interaction module 316 uses the user ID to identify user preferences stored in the preference database 312. The server interaction module 316 provides this information to other modules within the sound server 130 and receives trigger point information in return. The server interaction module 316 then provides this trigger point information to the requesting client 110.

An analysis module 318 analyzes the trigger point requests to identify corresponding trigger point information. Specifically, for a given trigger point request identifying a section of an eBook, the analysis module 318 identifies the location information for trigger points within that section. To determine the location information, the analysis module 318 accesses the trigger point database 310 for the identified eBook. The trigger point locations in an eBook may be explicitly specified in the text by the author, publisher or another party. In this case, the analysis module 318 accesses the trigger point database 310 to identify the explicit trigger points within the section of the eBook.

Trigger point locations may also be implicitly specified by the text. In this latter case, the analysis module 318 analyzes the eBook text within the identified section to identify locations of trigger points based on the words in the text. This analysis may include parsing the text to identify words or phrases matching an accompanying sound effect from the sound database 314. For example, the analysis module 318 may use regular-expression matching to identify phrases in the text, such as “lightning struck” and “birds were singing,” that match sounds in the sound database 314. The analysis module 318 establishes trigger points at the locations of these phrases.

The analysis module 318 also identifies the sound information for identified trigger points within the section of the eBook. As mentioned above, the sound information for an explicit trigger point may indicate a specific sound or a sound type to play at the trigger point, along with immediacy information for the sound. In one embodiment, if the sound information indicates a type of sound to play, the analysis module 318 analyzes the sound information in combination with the available sounds in the sound database 314 and/or user preferences in the preference database 312 to select a specific sound having the sound type to associate with the trigger point. For example, if the sound information indicates that a jazz song is to be played in association with the trigger point, and the user preferences indicate that the user likes a particular jazz song, the analysis module 318 may select that song to play in association with the trigger point. The analysis module 318 adds an ID of the selected sound to the sound information for the trigger point.

For an implicit trigger point, an embodiment of the analysis module 318 determines the sound to associate with the trigger point based on the text identified as the implicit trigger point. For example, the sound server 130 might select a thunder sound for the phrase “lightning struck.” The sound server 130 may also select the sound based on the context of the text, such as the words before or after the text, and based on user preferences. Likewise, an embodiment of the analysis module 318 determines immediacy information for the sound associated with the implicit trigger point based e.g., on contextual information or user preferences.

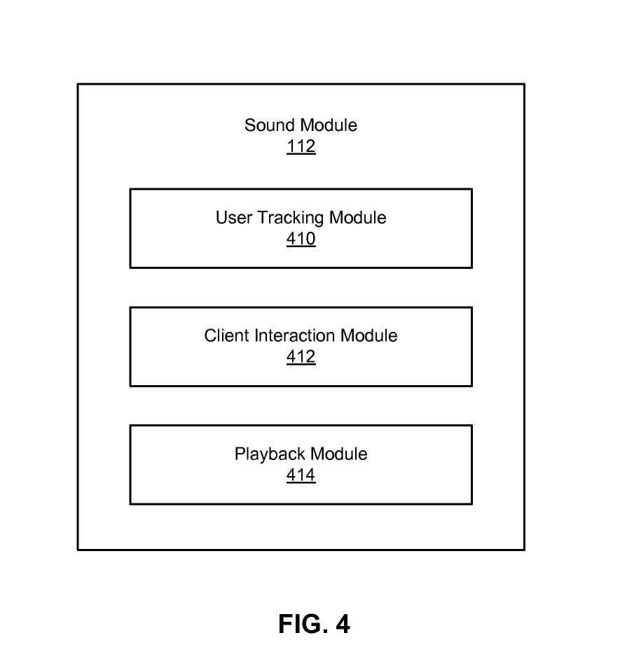

FIG. 4 is a high-level block diagram illustrating a detailed view of the sound module 112 of a client 110 according to one embodiment. As shown in FIG. 4, multiple modules are included within the sound module 112. In some embodiments, the functions are distributed among the modules in a different manner than described herein. Moreover, the functions are performed by other entities in some embodiments, such as by the sound server 130.

A user tracking module 410 calculates where in the text of an eBook a user is currently reading. This calculation may be accomplished through methods including eye tracking and time interval measurement. For example, sensors on the client 110 may track the eyes of the user to locate where in the text the user is looking. Similarly, the text that is currently being read may be estimated through measuring reading time intervals between page-turn commands. The time interval will vary for different users having different reading speeds, and will also vary depending upon the amount of text shown on each page and the complexity of the text. The estimated reading speed for a page of a given eBook for a user can be calculated by modifying the average expected reading speed with past reading speeds of the user. The client 110 can then estimate where on a page the user is currently reading.

A client interaction module 412 sends trigger point requests to the sound server 130. In one embodiment, the client interaction module 412 determines a section of eBook text for which trigger point information is needed, and sends a trigger point request for that section to the sound server 130. The section of text may be, e.g., a subsequent page about to be read by the user, a subsequent chapter, or even an entire eBook's text. For example, if the user anticipates having a limited network connection when reading an eBook, the user may instruct the client interaction module 412 to retrieve and store all trigger point information and associated sounds for offline use.

In addition, the client interaction module 412 may transmit user preference reports to the sound server 130. The client interaction module 412 subsequently receives the requested trigger point information from the sound server 130.

A playback module 414 plays sounds associated with trigger points based on the reading location of the user. In one embodiment, the playback module 414 uses the user tracking module 410 to track where the user is currently reading. When the playback module 414 detects that the user reaches the trigger point location, it plays the associated sound. The playback module 414 may use the immediacy information in the trigger point information, as well as user preferences, to decide how and when to play the sound.

To play a sound, an embodiment of the playback module 414 uses the sound information to retrieve the sound from the sound server 130 or elsewhere on the network 120. The playback module 414 may retrieve the sound prior to when the sound is to be played, such as when the user begins reading the eBook, the chapter or page containing the trigger point, or at another time.

In one embodiment, the playback module 414 identifies the sound information for trigger points, rather than this task being performed by the analysis module 318 of the sound server 130. In this embodiment, the trigger point information that the sound module 112 receives from the sound server 130 indicates the type of sound to play. The playback module 414 analyzes the sound information in combination with sounds available to the sound module 112 and/or user preferences to select a specific sound. This embodiment may be used, for example, when the user preferences and/or sounds are stored at the client 110.

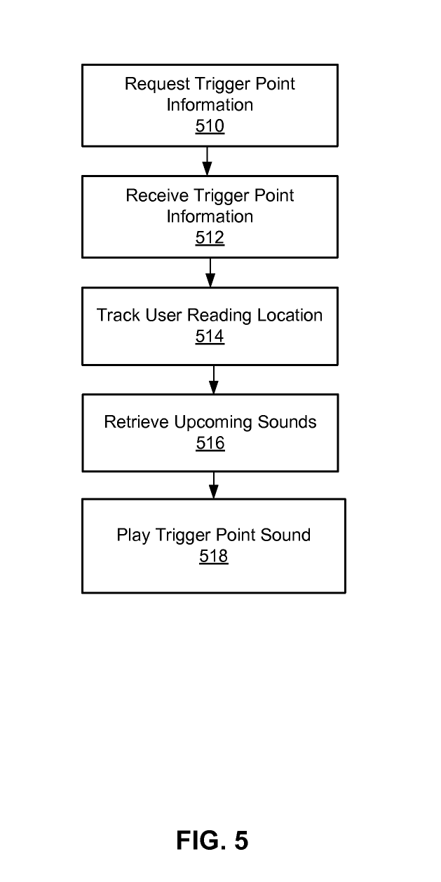

FIG. 5 is a flowchart illustrating a method of obtaining trigger point information and playing accompanying sounds according to one embodiment. While this description ascribes the steps of the method to the sound module 112, other entities can perform some or all of the steps in other embodiments. In addition, the method can perform the steps in different orders or include different steps.

In step 510, the sound module 112 requests trigger point information from the sound server 130 for a section of an eBook. In step 512, the sound module 112 receives the requested trigger point information identifying trigger points and associated sounds in the eBook. In step 514, the sound module 112 tracks the current reading location of the user on client 110. In step 516, if necessary, the sound module 112 retrieves sounds associated with upcoming trigger points. In step 518, when the user's reading location reaches the trigger point, the sound module 112 plays the associated sound.

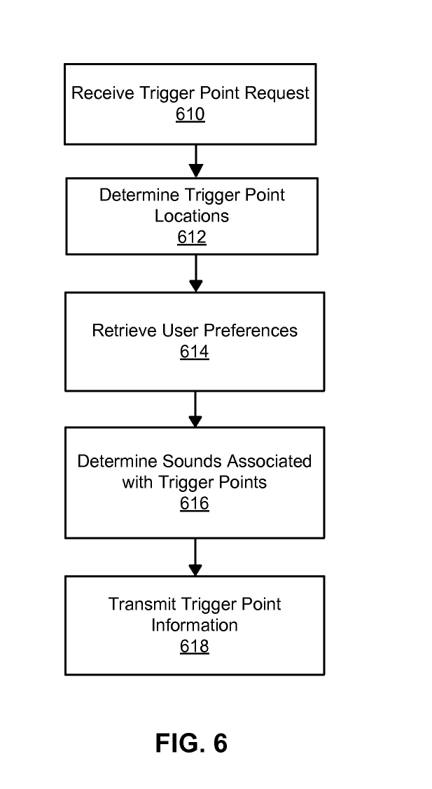

FIG. 6 is a flowchart illustrating a method of determining trigger point information and sending it to a client 110 according to one embodiment. While this description ascribes the steps of the method to the sound server 130, the clients 110 or other entities can perform some or all of the steps in other embodiments. In addition, the method can perform the steps in different orders or include different steps.

In step 610, the sound server 130 receives a trigger point request from a client 110 requesting trigger point information for a section of an eBook. In step 612, the sound server 130 determines trigger point locations within the section of the eBook. In one embodiment, the determined locations may include explicit trigger points and implicit trigger points. In step 614, the sound server 130 determines user preferences for the user who requested the trigger point information. In step 616, selection module 320 determines sounds information identifying sounds associated with trigger points, optionally based on the retrieved user preferences. In step 618, the trigger point information, including the trigger point locations and sounds are transmitted to the client 110 that sent the trigger point request.

Some sections of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for triggering sound playback during reading of eBooks. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

1. A computer-implemented method of triggering sounds in an eBook, comprising:
receiving a request for trigger point information for an eBook from a client;
determining trigger point information for the eBook, the trigger point information including location information identifying a location of a trigger point in the eBook and sound information indicating a sound to play at the trigger point; and
transmitting the determined trigger point information for the eBook to the client in response to the request.

2. The method of claim 1, wherein determining trigger point information comprises:
identifying a section of the eBook for which trigger point information is requested;
analyzing text of the eBook within the identified section to determine a location of an implicit trigger point within the text, the implicit trigger point having a word matching a sound available to be played at the trigger point; and
establishing a trigger point at the location of the implicit trigger point within the eBook text.

3. The method of claim 1, wherein determining trigger point information comprises:
determining a type of sound to play at the trigger point;
analyzing the type of sound in conjunction with a set of available sounds;
selecting a sound in the set having the determined type responsive to the analysis; and
including an identifier of the selected sound to the sound information.

4. The method of claim 3, wherein analyzing the type of sound further comprises:
analyzing the type of sound in conjunction with user preferences indicating sound selection preferences of the user.

5. The method of claim 1, wherein determining trigger point information comprises:
determining immediacy information indicating timing of when to play a sound responsive to the user reading the eBook at the location of the trigger point;
wherein the client is adapted to play the sound responsive to the immediacy information.

6. The method of claim 5, wherein the immediacy information indicates whether to play the sound concurrently with another sound.

7. The method of claim 1, further comprising:
receiving a user preference report from the client, the user preference report indicating a preference of the user with respect to sound selection;
wherein the sound information is determined responsive to the user preferences.

8. The method of claim 1, wherein the client is adapted to track a user's reading location in the eBook and play the indicated sound responsive to the user reading the eBook at the location of the trigger point.

9. A non-transitory computer-readable storage medium having executable computer program instructions embodied therein for triggering sounds in an eBook, the instructions comprising instructions for:
receiving a request for trigger point information for an eBook from a client;
determining trigger point information for the eBook, the trigger point information including location information identifying a location of a trigger point in the eBook and sound information indicating a sound to play at the trigger point; and
transmitting the determined trigger point information for the eBook to the client in response to the request.

10. The computer-readable storage medium of claim 9, wherein determining trigger point information comprises:
identifying a section of the eBook for which trigger point information is requested;
analyzing text of the eBook within the identified section to determine a location of an implicit trigger point within the text, the implicit trigger point having a word matching a sound available to be played at the trigger point; and
establishing a trigger point at the location of the implicit trigger point within the eBook text.

11. The computer-readable storage medium of claim 9, wherein determining trigger point information comprises:
determining a type of sound to play at the trigger point;
analyzing the type of sound in conjunction with a set of available sounds;
selecting a sound in the set having the determined type responsive to the analysis; and
including an identifier of the selected sound to the sound information.

12. The computer-readable storage medium of claim 11, wherein analyzing the type of sound further comprises:
analyzing the type of sound in conjunction with user preferences indicating sound selection preferences of the user.

13. The computer-readable storage medium of claim 9, wherein determining trigger point information comprises:
determining immediacy information indicating timing of when to play a sound responsive to the user reading the eBook at the location of the trigger point;
wherein the client is adapted to play the sound responsive to the immediacy information.

14. The computer-readable storage medium of claim 13, wherein the immediacy information indicates whether to play the sound concurrently with another sound.

15. The computer-readable storage medium of claim 9, further comprising instructions for:
receiving a user preference report from the client, the user preference report indicating a preference of the user with respect to sound selection;
wherein the sound information is determined responsive to the user preferences.

16. The computer-readable storage medium of claim 9, wherein the client is adapted to track a user's reading location in the eBook and play the indicated sound responsive to the user reading the eBook at the location of the trigger point.

17. A computer-implemented system for triggering sounds in an eBook, comprising:
a processor;
a non-transitory computer-readable storage medium having executable computer program instructions embodied therein, the instructions comprising instructions for:
determining trigger point information for the eBook, the trigger point information including location information identifying a location of a trigger point in the eBook and sound information indicating a sound to play at the trigger point; and
transmitting the determined trigger point information for the eBook to the client in response to the request.

18. The system of claim 17, wherein determining trigger point information comprises:
identifying a section of the eBook for which trigger point information is requested;
analyzing text of the eBook within the identified section to determine a location of an implicit trigger point within the text, the implicit trigger point having a word matching a sound available to be played at the trigger point; and
establishing a trigger point at the location of the implicit trigger point within the eBook text.

19. The system of claim 17, wherein determining trigger point information comprises:
determining a type of sound to play at the trigger point;
analyzing the type of sound in conjunction with a set of available sounds;
selecting a sound in the set having the determined type responsive to the analysis; and
including an identifier of the selected sound to the sound information.

20. The system of claim 19, wherein analyzing the type of sound further comprises:
analyzing the type of sound in conjunction with user preferences indicating sound selection preferences of the user.

21. The system of claim 17, wherein determining trigger point information comprises:
determining immediacy information indicating timing of when to play a sound responsive to the user reading the eBook at the location of the trigger point;
wherein the client is adapted to play the sound responsive to the immediacy information.

22. The system of claim 21, wherein the immediacy information indicates whether to play the sound concurrently with another sound.

23. The system of claim 17, further comprising:
receiving a user preference report from the client, the user preference report indicating a preference of the user with respect to sound selection;
wherein the sound information is determined responsive to the user preferences.

24. The system of claim 17, wherein the client is adapted to track a user's reading location in the eBook and play the indicated sound responsive to the user reading the eBook at the location of the trigger point.
